(19) United States
(12) Patent Application Publication
(10) Pub. No.: US 2026/0290358 A1
(43) Pub. Date: Sep. 24, 2026

(54) ENCODER AND DECODER FOR CODING SIGNAL BASED ON ANNOTATION AND METHOD OF OPERATING THE SAME

(71) Applicant: Electronics and Telecommunications Research Institute, Daejeon (KR)

(72) Inventors: Inseon JANG, Daejeon (KR); Yong Ju LEE, Daejeon (KR); Soo Young PARK, Daejeon (KR); Seung Kwon BEACK, Daejeon (KR); Jongmo SUNG, Daejeon (KR); Woo-taek LIM, Daejeon (KR); Young Ho JEONG, Daejeon (KR); Byeongho CHO, Daejeon (KR)

(73) Assignee: Electronics and Telecommunications Research Institute, Daejeon (KR)

(21) Appl. No.: 19/567,554

(22) Filed: Mar. 16, 2026

(30) Foreign Application Priority Data
Mar. 20, 2025 (KR) 10-2025-0036273
Mar. 5, 2026 (KR) 10-2026-0040043

(51) Int. Cl. G10L 19/018

(52) U.S. Cl. CPC G10L 19/018

(57) ABSTRACT

An encoder and decoder for coding a signal based on an annotation and a method of operating the same are disclosed. The method of operating an encoder includes obtaining metadata of a signal and encoding the metadata to generate a bitstream corresponding to the metadata, in which the metadata includes an annotation group representing information expected to be inferred by a machine while performing a task related to the signal.

### CROSS-REFERENCE TO RELATED APPLICATIONS

This application claims the benefit of Korean Patent Application No. 10-2025-0036273, filed on Mar. 20, 2025, and Korean Patent Application No. 10-2026-0040043, filed on Mar. 5, 2026, in the Korean Intellectual Property Office (now the Ministry of Intellectual Property (MOIP)), the entire disclosures of which are incorporated herein by reference for all purposes.

### BACKGROUND

### 1. Field of the Invention

One or more embodiments relate to an encoder and decoder for coding a signal based on an annotation and a method of operating the same.

### 2. Description of the Related Art

A waveform audio file format (WAVE) file or a broadcast wave format (BWF) file may be used to store an audio signal and transmit the audio signal. Additional information related to the audio signal may be included in the header of the WAVE file. For example, the number of channels and a sampling rate may be included in the header of the WAVE file.

The need for machine listening has recently emerged in various applications, and the Moving Picture Experts Group (MPEG) has studied audio coding for machines (ACoM), a technology for coding audio signals intended for machine processing.

The above description has been possessed or acquired by the inventor(s) in the course of conceiving the present disclosure and is not necessarily an art publicly known before the present application is filed.

### SUMMARY

Embodiments provide encoding and decoding a signal based on metadata including an annotation group representing information expected to be inferred by a machine while performing a task related to the signal during a signal coding process.

However, technical aspects are not limited to the foregoing aspects, and there may be other technical aspects.

According to an aspect, there is provided a method of operating an encoder, the method including obtaining metadata of a signal and encoding the metadata to generate a bitstream corresponding to the metadata, in which the metadata includes an annotation group representing information expected to be inferred by a machine while performing a task related to the signal.

The metadata may further include a first field indicating the number of annotation groups included in the metadata.

The annotation group may include a second field indicating a type of annotation included in the metadata.

The annotation group may include a third field indicating a time-varying annotation value included in the metadata.

The annotation group may include a fourth field indicating a start time of an annotation included in the metadata and a fifth field indicating an end time of the annotation included in the metadata.

The annotation group may include information regarding at least one of a semantic or a characteristic of the signal.

The generating of the bitstream may include encoding the metadata based on audio coding for machines (ACoM).

According to an aspect, there is provided a method of operating a decoder, the method including obtaining a bitstream of an encoded signal and decoding the bitstream to reconstruct metadata of the signal, in which the metadata includes an annotation group representing information expected to be inferred by a machine while performing a task related to the signal.

The metadata may further include a first field indicating the number of annotation groups included in the metadata.

The annotation group may include a second field indicating a type of annotation included in the metadata.

The annotation group may include a third field indicating a time-varying annotation value included in the metadata.

The annotation group may include a fourth field indicating a start time of an annotation included in the metadata and a fifth field indicating an end time of the annotation included in the metadata.

The annotation group may include information regarding at least one of a semantic or a characteristic of the signal.

The reconstructing of the metadata may include decoding the bitstream based on ACoM.

According to an aspect, there is provided an encoder including a processor and memory storing instructions, in which the instructions, when executed by the processor, cause the encoder to obtain metadata of a signal and encode the metadata to generate a bitstream corresponding to the metadata, in which the metadata includes an annotation group representing information expected to be inferred by a machine while performing a task related to the signal.

The metadata may further include a first field indicating the number of annotation groups included in the metadata.

The annotation group may include a second field indicating a type of annotation included in the metadata.

The annotation group may include a third field indicating a time-varying annotation value included in the metadata.

The annotation group may include a fourth field indicating a start time of an annotation included in the metadata and a fifth field indicating an end time of the annotation included in the metadata.

Additional aspects of embodiments will be set forth in part in the description which follows and, in part, will be apparent from the description, or may be learned by practice of the disclosure.

According to embodiments, including an annotation group in metadata used to code a signal enables the improvement of the usability of the metadata and allows the information required to be efficiently and effectively stored and transmitted through a bitstream.

According to embodiments, using an annotation group enables more efficient and easier training and processing of a signal, such as classifying or generating the signal, in machine learning.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 is a diagram illustrating a pipeline of audio coding for machines (ACoM) according to an embodiment;

FIG. 2 is a diagram illustrating an architecture of ACoM according to an embodiment;

FIG. 3 is a diagram illustrating a structure of a bitstream of ACoM according to an embodiment;

FIG. 4 is a diagram illustrating metadata according to an embodiment;

FIG. 5 is a diagram illustrating an annotation group according to an embodiment;

FIG. 6 is a flowchart illustrating a method of operating an encoder according to an embodiment;

FIG. 7 is a flowchart illustrating a method of operating a decoder according to an embodiment;

FIG. 8 is a block diagram illustrating an encoder according to an embodiment; and

FIG. 9 is a block diagram illustrating a decoder according to an embodiment.

### DETAILED DESCRIPTION

The following detailed structural or functional description is provided as an example only and various alterations and modifications may be made to the examples. Accordingly, the embodiments are not construed as limited to the disclosure and should be understood to include all changes, equivalents, and replacements within the idea and the technical scope of the disclosure.

Terms, such as first, second, and the like, may be used herein to describe components. Each of these terminologies is not used to define an essence, order or sequence of a corresponding component but used merely to distinguish the corresponding component from other component(s). For example, a first component may be referred to as a second component, and similarly the second component may also be referred to as the first component.

It should be noted that if it is described that one component is “connected”, “coupled”, or “joined” to another component, a third component may be “connected”, “coupled”, and “joined” between the first and second components, although the first component may be directly connected, coupled, or joined to the second component.

As used herein, the singular form is intended to include the plural forms as well, unless the context clearly indicates otherwise. As used herein, “A or B,” “at least one of A and B,” “at least one of A or B,” A, B or C,” “at least one of A, B and C,” and “at least one of A, B, or C,” each of which may include any one of the items listed together in the corresponding one of the phrases, or all possible combinations thereof. It will be further understood that the terms “comprises/including” and/or “includes/including” when used herein, specify the presence of stated features, integers, operations, operations, elements, and/or components, but do not preclude the presence or addition of one or more other features, integers, operations, operations, elements, components and/or groups thereof.

Unless otherwise defined, all terms, including technical and scientific terms, used herein have the same meaning as commonly understood by one of ordinary skill in the art to which this disclosure pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used in connection with the present disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, the module may be implemented in the form of an application-specific integrated circuit (ASIC).

The term “unit” used herein may refer to a software or hardware component, such as a field-programmable gate array (FPGA) or an ASIC, and the “unit” performs predefined functions. However, “unit” is not limited to software or hardware. The “unit” may be configured to reside on an addressable storage medium or configured to operate one or more processors. Accordingly, the “unit” may include, for example, components, such as software components, object-oriented software components, class components, and task components, processes, functions, attributes, procedures, sub-routines, segments of program code, drivers, firmware, microcode, circuitry, data, databases, data structures, tables, arrays, and variables. The functionalities provided in the components and “units” may be combined into fewer components and “units” or may be further separated into additional components and “units.” Furthermore, the components and “units” may be implemented to operate on one or more central processing units (CPUs) within a device or a security multimedia card. In addition, “unit” may include one or more processors.

Hereinafter, the examples will be described in detail with reference to the accompanying drawings. When describing the embodiments with reference to the accompanying drawings, like reference numerals refer to like elements and a repeated description related thereto will be omitted.

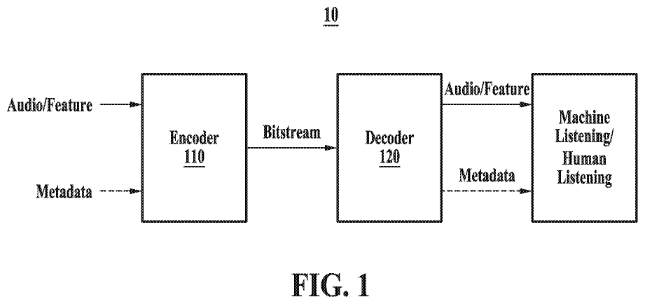

FIG. 1 is a diagram illustrating a pipeline of audio coding for machines (ACoM) according to an embodiment.

Referring to FIG. 1, according to an embodiment, machine listening may be used in various applications. For example, machine listening may be used for predictive maintenance, process control, testing, traffic monitoring, construction site monitoring, speech recognition, acoustic scene analysis, medical data analysis, and/or artistic creation. The Moving Picture Experts Group (MPEG) has been standardizing an audio signal encoding technology related to machine listening, and the technology may be referred to as ACoM.

A coding system 10 for ACoM may include an encoder 110 and a decoder 120.

The encoder 110 may generate a bitstream based on encoding input data and transmit the bitstream to the decoder 120. The decoder 120 may reconstruct the input data from the bitstream. The reconstructed input data may be used for machine listening or human listening.

According to an embodiment, input data may be a signal. The signal may include an audio signal or a video signal, as well as an electroencephalogram (EEG) signal, an electrocardiogram (ECG) signal, and an electromyography (EMG) signal, but embodiments are not limited thereto. For ease of description, the signal may also be referred to as an audio signal herein.

The input data of the encoder 110 may include an audio signal, metadata, features, and/or other multi-dimensional streams.

The features may be feature information (e.g., feature information of an audio signal) used by an artificial intelligence (AI) model to perform a task using the audio signal.

The metadata may be additional information related to an audio signal. The metadata may be defined (or classified) based on groups as higher-level categories and fields as subcategories of the groups.

The groups of the metadata may be classified into mandatory groups that are required and optional groups that are optionally present. For example, “General” and “Rights” may be mandatory groups, and “Sensor”, “Object”, and “Further” may be optional groups.

Like the groups of the metadata, the fields of the metadata may be classified into mandatory fields, which are required when a group to which the fields belong is present, and optional fields, which are optionally present.

According to an embodiment, the groups of the metadata may include an annotation group “Annotation”. The annotation group may include information regarding at least one of a semantic or a characteristic of the signal. For example, the annotation group may include information indicating that a signal corresponding to the metadata represents a human voice, a cat sound, or a dog sound. Accordingly, the annotation group may enable the information to be included in the metadata and converted into a bitstream together with the signal, without being provided as a separate file or data.

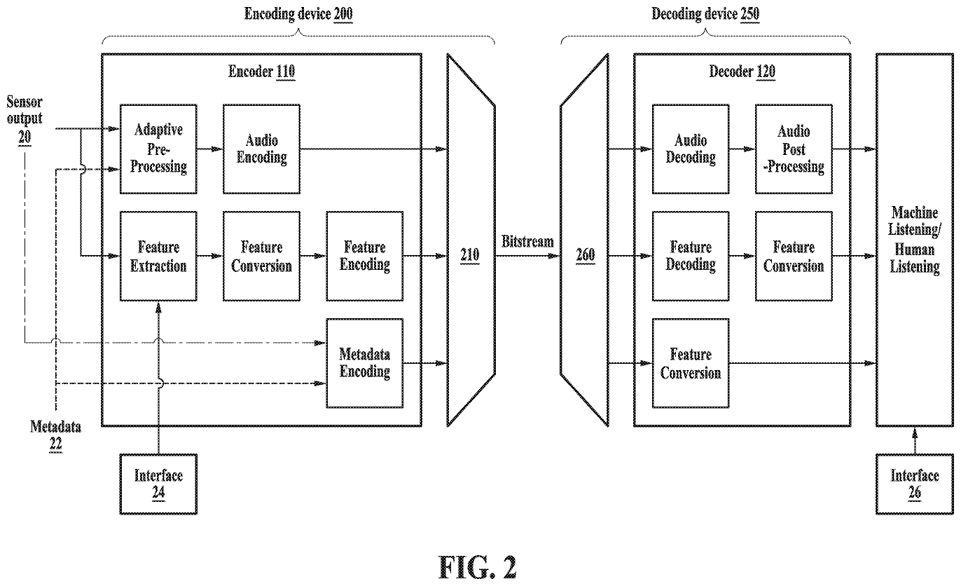

FIG. 2 is a diagram illustrating an architecture of ACoM according to an embodiment.

Referring to FIG. 2, according to an embodiment, an encoding device 200 may include an encoder 110 and a multiplexer 210, and a decoding device 250 may include a decoder 120 and a demultiplexer 260.

The encoder 110 may include one or more modules (e.g., software modules) for encoding a sensor output 20 (e.g., an audio signal), metadata 22 (e.g., ACoM metadata), and/or features, and the decoder 120 may include one or more modules (e.g., software modules) for reconstructing the sensor output 20, the metadata 22, and/or the features from a bitstream. The structure of the encoder 110 and the structure of the decoder 120 illustrated in FIG. 2 are only examples for describing a technical concept of the present disclosure, and the scope of the present disclosure is not limited thereto.

The encoder 110 may preprocess the sensor output 20 and generate a bitstream corresponding to the sensor output 20 based on encoding the preprocessed sensor output.

The encoder 110 may extract features from original data (e.g., an audio signal) and generate a bitstream corresponding to the features based on encoding the features. The original data of the features may be obtained through an interface 24 for interaction with an AI model (e.g., a neural network module). The interface 24 may be included in the encoding device 200 or may be implemented separately from the encoding device 200.

The encoder 110 may generate a bitstream corresponding to the metadata 22 based on encoding the metadata 22.

The multiplexer 210 may generate a single bitstream (e.g., an ACoM bitstream) based on the bitstream corresponding to the sensor output 20, the bitstream corresponding to the features, and the bitstream corresponding to the metadata 22. For example, the multiplexer 210 may generate a single bitstream by combining the bitstream corresponding to the sensor output 20, the bitstream corresponding to the features, and the bitstream corresponding to the metadata 22.

The demultiplexer 260 may separate a single bitstream into a bitstream corresponding to the sensor output 20, a bitstream corresponding to the features, and a bitstream corresponding to the metadata 22.

The decoder 120 may reconstruct the sensor output 20 based on decoding the bitstream corresponding to the sensor output 20.

The decoder 120 may reconstruct the features based on decoding the bitstream corresponding to the features.

The decoder 120 may reconstruct the metadata 22 based on decoding the bitstream corresponding to the metadata 22.

A reconstructed sensor output (e.g., a reconstructed audio signal), reconstructed features, and/or reconstructed metadata may be used as input data for machine listening and/or human listening. The interface 26 for interaction with an AI model (e.g., a neural network module) may be used for machine listening. The interface 26 may be included in the decoding device 250 or may be implemented separately from the decoding device 250.

The decoder 120 may perform a task related to machine listening and provide a result of the task to a user.

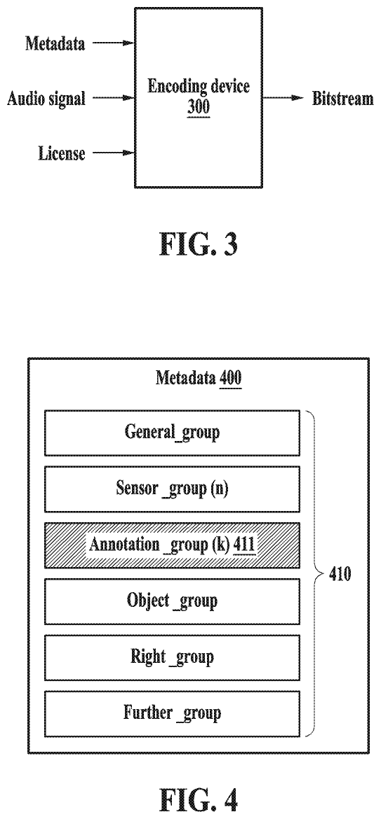

FIG. 3 is a diagram illustrating a structure of a bitstream of ACoM according to an embodiment.

Referring to FIG. 3, according to an embodiment, an ACoM bitstream may include information related to audio essence (e.g., an audio signal), information related to metadata (e.g., ACoM metadata), and/or information related to a license.

An encoding device 300 may receive metadata, an audio signal, and a license as input and may generate a bitstream (e.g., an ACoM bitstream) based on the metadata, the audio signal, and the license. For example, the structure of the bitstream may be as shown in Table 1. However, Table 1 is only an example for describing a technical concept of the present disclosure, and the scope of the present disclosure is not limited thereto.

TABLE 1

| | |
|---|---|
| Syntax | No. of bits |

```
ACOM Bitstream( )
{
  ACOM_Metadata_Bitstream( )
  ACOM_Audio_Bitstream( )
  ACOM_License_Bitstream( )
}
Sum. No. of bits
```

FIG. 4 is a diagram illustrating metadata according to an embodiment.

Referring to FIG. 4, an example of metadata 400 for a signal is illustrated. The metadata 400 may include a plurality of groups 410. According to an embodiment, the metadata 400 may include an annotation group 411. In addition, the metadata 400 may further include a general group, a sensor group, an object group, a rights group, and a further group. However, the metadata 400 illustrated in FIG. 4 is only an example for description, and embodiments are not limited thereto.

The general group may represent a description of a recording situation of an audio signal. The annotation group 411 may describe information expected to be inferred by a machine while performing a task. The object group may describe a recorded object. The rights group may describe rights for using data.

Each group included in the metadata 400 may include one or more fields. For example, each group included in metadata may include one or more fields as shown in Table 2 below. The fields shown in Table 2 below are mostly optional and may vary depending on the embodiment.

TABLE 2

| Group | Field |
|---|---|
| General | SamplingRate |
| | Channels |
| | Duration |
| | AudioFormat |
| | Humidity |
| | Temperature |
| | AirPressure |
| | NmberOfSensors |
| | NmberOfAnnotations |
| | DateTime |
| Sensor | Id |
| | File |
| | SensorType |
| | SensorDirectivity |
| | SensorPosition |
| | SensorTolerance |
| | SensorDirection |
| | SensorDirectionTolerance |
| | SensorGain |
| Annotation | Id |
| | File |
| | AudioFile |
| | AnnotationType |
| | AnnotationValue |
| | Onset |
| | Offset |
| Object | Name |
| | OperationMode |
| | ObjPosPrecision |
| | ObjOrientation |
| | ObjOrientDescr |
| | ObjOrientTolerance |
| | Transcript |
| | Age |
| | AgeCategory |
| | Gender |
| | RespiratoryCondition |
| | FeverMusclePain |
| | Height |
| | Weight |
| | PregnancyStatus |
| | Murmur |
| Rights | Type |
| | File |
| | ContentOwner |
| Further | Category |
| | Usage |

The annotation group 411 may include information expected to be inferred by a machine while performing a task, and a human labeling task may generally be required. The information may enable machine learning and facilitate standardized data exchange and may be important for simplifying use in various industries.

According to an embodiment, the general group may include a first field, “NmberOfAnnotations”, indicating the number of annotation groups included in the metadata. For ease of description, the first field may also be referred to as “NmberOfAnnotations” herein. The value of the first field may be “String”.

In addition, the general group may include fields for describing the number of channels of a signal, a sampling rate, a date and time of obtainment, and temperature and humidity at the time of obtainment. For example, the general group may include fields “SamplingRate”, “AudioFormat”, “Humidity”, “Temperature”, “AirPressure”, “NumberOfSensors”, and “DateTime”.

The object group may include information related to an object serving as a source of a signal. For example, the object group may include fields “Name”, “OperationMode”, “ObjPosPrecision”, “ObjOrientation”, “ObjOrientDescr”, “ObjOrientTolerance”, and “Transcript”.

“Name” may be a field indicating a verbal description of an object. For instance, “Name” may have as a value a name of a person corresponding to a source of an audio signal. “OperationMode” may be a field indicating an operation mode such as “heavy load”, “broken”, “gear defect”, or “motor blocked”. “OperationMode” may include specifications regarding processed materials and tools used when a machine has different tools. “ObjPosPrecision” may be a field indicating tolerances (e.g., in meters) of Cartesian coordinates of an object, separated by commas. “ObjOrientation” may be a field for an orthogonal vector indicating a direction of an object. “ObjOrientDescr” may be a field for text describing the semantics of “ObjOrientation”. “ObjOrientTolerance” may be a field indicating a tolerance of “ObjOrientation”. “Transcript” may be a field including a transcript (ground truth) of spoken words in content including voice recordings.

When “OperationMode” has time-varying annotation values, “OperationMode” may need to be described using “AnnotationType” in an annotation group.

The annotation group 411 may include an “Id” field as a unique identifier of an annotation. The value of the “Id” field may be “String”.

The annotation group 411 may include a “File” field indicating a file name of an annotation. When the annotation group 411 includes the “File” field, the “AnnotationValue”, “Onset”, and “Offset” fields may not be permitted. The value of the “File” field may be a file name having a data type of “String”.

The annotation group 411 may include an “AudioFile” field indicating a file name of a recording channel associated with an annotation. The value of the “AudioFile” field may be “String”.

The annotation group 411 may include a second field, “AnnotationType”, indicating a type of an annotation included in the metadata. For ease of description, the second field may also be referred to as “AnnotationType” herein. For example, the second field may indicate a type of semantic or characteristic associated with the annotation. For instance, the second field may have a value such as “OperationMode”, “SoundEvent”, “FaultStatus”, “Transcript”, “Gender”, “SpeakerName”, or “AudioSceneClass”. The value of the second field may be “String”.

The annotation group 411 may include a third field, “AnnotationValue”, indicating a time-varying annotation value included in the metadata. For ease of description, the third field may also be referred to as “AnnotationValue” herein. When the annotation group 411 includes the third field, the “File” field may not be permitted. The third field may indicate an actual value of the annotation, which may vary over time. For example, when the value of the second field is “SoundEvent”, the third field may have a value such as “Music” or “Speech”. The value of the third field may be “String”.

According to an embodiment, each annotation group 411 may have a single annotation value. The metadata 400 may include one or more annotation groups, and each annotation group 411 may have a corresponding annotation value.

The annotation group 411 may include a fourth field, “Onset”, indicating a start time of an annotation included in the metadata and a fifth field, “Offset”, indicating an end time of the annotation included in the metadata. For ease of description, the third field and the fourth field may also be referred to as “Onset” and “Offset”, respectively, herein. When the annotation group 411 includes the fourth field, the “File” field may not be permitted. In addition, when the annotation group 411 includes the fifth field, the “File” field may not be permitted. The values of the fourth field and the fifth field may be “String”.

According to an embodiment, one or more annotation groups may be defined in the metadata 400 for the same time segment of a signal. For example, one or more annotation groups may be defined for overlapping time segments based on the values of the fourth field and the fifth field. For instance, when a sound corresponding to “Vacuum cleaner” and a sound corresponding to “dog bark” are simultaneously included in a specific time segment of an audio signal, an annotation group corresponding to “Vacuum cleaner” and an annotation group corresponding to “dog bark”, respectively including the fourth field and the fifth field indicating the specific time segment, may be included in the metadata 400.

When a bitstream is generated based on the metadata 400, each group may be represented as shown in Table 3 below. However, the bitstream generation syntax illustrated in FIG. 3 is only an example for description, and embodiments are not limited thereto.

TABLE 3

| | | |
|---|---|---|
| | No. of | |
| Syntax | bits | Others |

| | |
|---|---|
| ACOM_metadata_bitstream( ) | |
| { | |
| General_Group( ); | |
| for (unsigned int n = 0; n < NumberOfSensors; | |
| n++) { | |
| Sensor_Group( ); | |
| } | |
| for (unsigned int n = 0; n < NumberOfAnnotations; | |
| n++) { | |
| Annotation_Group( ); | |
| } | |
| Object_Group_Presence_flag ; | 8 (1) |
| Object_Group( ); | |
| Right_Group( ); | |
| number_of_Further_Group; | 16 |
| for (unsigned int n = 0; n < | |
| number_of_Further_Group; n++) { | |
| Further_Group( ); | |
| } | |
| } | |

When a bitstream is generated based on the general group, each group may be represented as shown in Table 4 below. However, the bitstream generation syntax illustrated in FIG. 4 is only an example for description, and embodiments are not limited thereto.

TABLE 4

| | | |
|---|---|---|
| Syntax | No. of bits | Others |

```
General_Group( )
{
  SamplingRate;
  Channels;
  Duration;
  AudioFormat;
  Humidity;
  Temperature;
  AirPressure;
  NumberOfSensors;
  NumberOfAnnotations;
  DateTime;
}
```

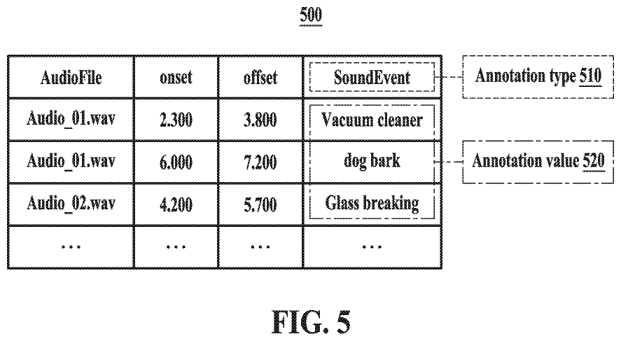

When a bitstream is generated based on the annotation group, each group may be represented as shown in Table 5 below. However, the bitstream generation syntax illustrated in FIG. 5 is only an example for description, and embodiments are not limited thereto.

TABLE 5

| | | |
|---|---|---|
| Syntax | No. of bits | Others |

```
Annotation_Group( )
{
  Id
  File*
  AudioFile
  AnnotationType
  AnnotationValue
  Onset
  Offset
}
```

FIG. 5 is a diagram illustrating an annotation group according to an embodiment.

Referring to FIG. 5, an example of the structure of an annotation file 500 is illustrated. The annotation file 500 may include an annotation type 510 for a signal and an annotation value 520 corresponding to the annotation type 510.

According to an embodiment, the annotation file 500 may be structured in a comma-separated values (CSV) format, and column headers may be specified in the first row. The headers may vary depending on the annotation type 510. In addition, the headers may correspond to fields included in the annotation group. For time-varying annotations, the headers may include “AudioFile”, “Onset”, “Offset”, and “AnnotationType”. Here, “AudioFile” and “AnnotationType” may correspond to fields defined in the annotation group. The fields may indicate a start time and an end time of an annotation value and an actual value associated with a specified “AnnotationType”. The annotation file 500 illustrated in FIG. 5 may be an example of a CSV file used for time-varying annotations. Each row may specify an audio file associated with an annotation, a start time and an end time of a sound event, and a label describing the sound event.

According to an embodiment, the semantics of each annotation value 520 may be determined based on the annotation type 510, “AnnotationType”. For example, when “AnnotationType” is “OperationMode”, the annotation value 520 may describe a state of a machine, such as “idle”, “heavy load”, or “motor blocked”. Alternatively, when “AnnotationType” is “SoundEvent”, the annotation value 520 may indicate a type of sound event detected during a specified time segment. For example, the annotation value 520 may be “dog bark”, “vacuum cleaner”, or “glass breaking”. Static annotations may provide consistent information throughout an entire audio recording. A static annotation may represent an annotation in which the annotation type 510 of an audio signal remains the same throughout an entire time segment. For static annotations, an annotation may include two fields, “AudioFile” and “AnnotationType”, and the values of the fields may be applied to an entire file without temporal metadata.

For example, the annotation type 510 may represent a type of task on which a machine receiving a signal performs learning (e.g., deep learning), and the annotation value 520 may indicate actual content included in the signal. For instance, when the annotation type 510 is “animal sound”, the annotation value 520 may be “dog bark”, “cat sound”, or “bird sound”. In addition, when the annotation type 510 is “construction tool sound”, the annotation value 520 may be “hammer sound”, “drill sound”, or “sawing sound”.

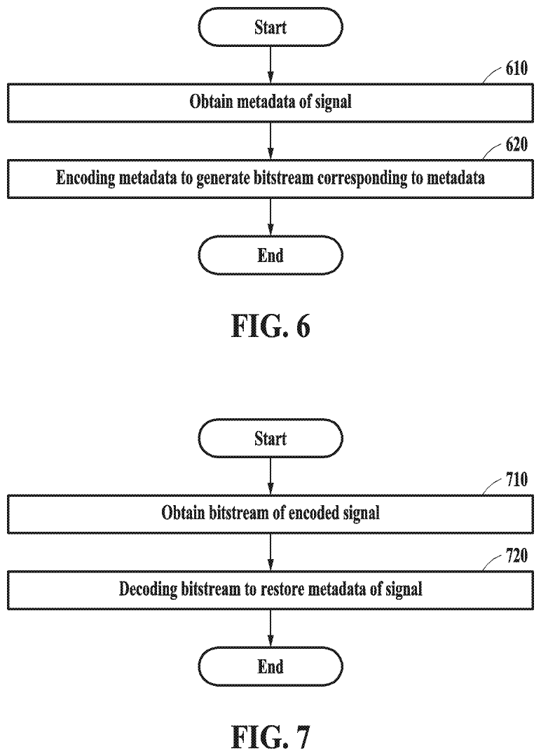

FIG. 6 is a flowchart illustrating a method of operating an encoder according to an embodiment.

In the following embodiments, operations may or may not be performed sequentially. For example, the order of the operations may be changed and at least two of the operations may be performed in parallel. Operations 610 and 620 may be performed by at least one component (e.g., a processor) of the encoder.

In operation 610, the encoder may obtain metadata of a signal.

In operation 620, the encoder may encode metadata to generate a bitstream corresponding to the metadata. The encoder may encode the metadata based on ACoM.

The metadata may include an annotation group representing information expected to be inferred by a machine while performing a task related to the signal. The metadata may further include a first field indicating the number of annotation groups included in the metadata. The annotation group may include a second field indicating a type of annotation included in the metadata. The annotation group may include a third field indicating a time-varying annotation value included in the metadata. The annotation group may include a fourth field indicating a start time of an annotation included in the metadata and a fifth field indicating an end time of the annotation included in the metadata. The annotation group may include information regarding at least one of a semantic or a characteristic of the signal.

The operations illustrated in FIG. 6 may be performed based on the descriptions provided with reference to FIGS. 1 to 5, and thus, repeated descriptions thereof are omitted.

FIG. 7 is a flowchart illustrating a method of operating a decoder according to an embodiment.

In the following embodiments, operations may or may not be performed sequentially. For example, the order of the operations may be changed and at least two of the operations may be performed in parallel. Operations 710 and 720 may be performed by at least one component (e.g., a processor) of the decoder.

In operation 710, the decoder may obtain a bitstream of an encoded signal.

In operation 720, the decoder may decode the bitstream to reconstruct metadata of the signal. The decoder may decode the bitstream based on ACoM.

The metadata may include an annotation group representing information expected to be inferred by a machine while performing a task related to the signal. The metadata may further include a first field indicating the number of annotation groups included in the metadata. The annotation group may include a second field indicating a type of annotation included in the metadata. The annotation group may include a third field indicating a time-varying annotation value included in the metadata. The annotation group may include a fourth field indicating a start time of an annotation included in the metadata and a fifth field indicating an end time of the annotation included in the metadata. The annotation group may include information regarding at least one of a semantic or a characteristic of the signal.

The operations illustrated in FIG. 7 may be performed based on the descriptions provided with reference to FIGS. 1 to 6, and thus, repeated descriptions thereof are omitted.

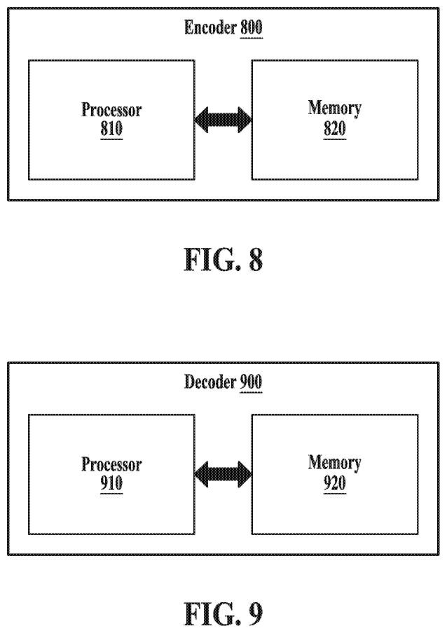

FIG. 8 is a block diagram illustrating an encoder according to an embodiment.

Referring to FIG. 8, an encoder 800 may include a processor 810. The processor 810 may include at least one processor. In addition, the encoder 800 may further include memory 820.

The memory 820 may store instructions (or programs) executable by the processor 810. For example, the instructions may include instructions for performing the operation of the processor 810 and/or the operation of each component of the processor 810.

The processor 810 may be a device for executing instructions or programs or controlling the encoder 800, and may include, for example, various processors, such as a CPU or a graphics processing unit (GPU). The processor 810 may obtain metadata of a signal. The processor 810 may encode the metadata to generate a bitstream corresponding to the metadata.

The processor 810 may encode the metadata based on ACoM.

In addition, the encoder 800 may process the operations described above.

FIG. 9 is a block diagram illustrating a decoder according to an embodiment.

Referring to FIG. 9, an encoder 900 may include a processor 910. The processor 910 may include at least one processor. In addition, the decoder 900 may further include memory 920.

The memory 920 may store instructions (or programs) executable by the processor 910. For example, the instructions may include instructions for performing the operation of the processor 910 and/or the operation of each component of the processor 910.

The processor 910 may be a device for executing instructions or programs or controlling the decoder 900, and may include, for example, various processors, such as a CPU or a GPU. The processor 910 may obtain a bitstream of an encoded signal. The processor 910 may decode the bitstream to reconstruct metadata of the signal.

The processor 910 may decode the bitstream based on ACoM.

In addition, the decoder 900 may process the operations described above.

The examples described herein may be implemented using a hardware component, a software component, and/or a combination thereof. For example, the devices, the methods, and the components described in the embodiments may be implemented using a general-purpose or special-purpose computer, such as a processor, a controller and an arithmetic logic unit (ALU), a digital signal processor (DSP), a microcomputer, an FPGA, a programmable logic unit (PLU), a microprocessor, or any other devices capable of responding to and executing instructions. The processing device may run an operating system (OS) and one or more software applications that run on the OS. In addition, the processing device also may access, store, control, process, and generate data in response to execution of the software. For purpose of simplicity, the description of a processing unit is used as singular; however, one skilled in the art will appreciate that a processing unit may include a plurality of processing elements and a plurality of types of processing elements. For example, the processing unit may include a plurality of processors, or a single processor and a single controller. In addition, different processing configurations are possible, such as parallel processors.

The software may include a computer program, a piece of code, an instruction, or some combinations thereof, to independently or collectively instruct or configure the processing device to operate as desired. Software and data may be stored in any type of machine, component, physical or virtual equipment, or computer storage medium or device capable of providing instructions or data to or being interpreted by the processing unit. The software may also be distributed over network-coupled computer systems so that the software is stored and executed in a distributed fashion. The software and data may be stored by one or more non-transitory computer-readable recording mediums.

The methods according to the above-described embodiments may be recorded in non-transitory computer-readable media including program instructions to implement various operations of the above-described embodiments. The media may also include, alone or in combination with the program instructions, data files, data structures, and the like. The program instructions recorded on the media may be those specially designed and constructed for the purposes of examples, or they may be of the kind well-known and available to those having skill in the computer software arts. Examples of non-transitory computer-readable media include magnetic media such as hard disks, floppy disks, and magnetic tape; optical media such as CD-ROM discs and/or DVDs; magneto-optical media such as optical discs; and hardware devices that are specially configured to store and perform program instructions, such as read-only memory (ROM), random-access memory (RAM), flash memory, and the like. Examples of program instructions include both machine code, such as produced by a compiler, and files containing higher-level code that may be executed by the computer using an interpreter.

The above-described hardware devices may be configured to act as one or more software modules in order to perform the operations of the above-described embodiments, or vice versa.

As described above, although the examples have been described with reference to the limited drawings, a person skilled in the art may apply various technical modifications and variations based thereon. For example, suitable results may be achieved if the described techniques are performed in a different order, and/or if components in a described system, architecture, device, or circuit are combined in a different manner, or replaced or supplemented by other components or their equivalents.

Therefore, the scope of the disclosure is defined not by the detailed description, but by the claims and their equivalents, and all variations within the scope of the claims and their equivalents are to be construed as being included in the disclosure.

What is claimed is:

1. A method of operating an encoder, the method comprising:
obtaining metadata of a signal; and
encoding the metadata to generate a bitstream corresponding to the metadata,
wherein the metadata comprises an annotation group representing information expected to be inferred by a machine while performing a task related to the signal.

2. The method of claim 1, wherein the metadata further comprises a first field indicating a number of annotation groups included in the metadata.

3. The method of claim 1, wherein the annotation group comprises a second field indicating a type of annotation included in the metadata.

4. The method of claim 1, wherein the annotation group comprises a third field indicating a time-varying annotation value included in the metadata.

5. The method of claim 1, wherein the annotation group comprises a fourth field indicating a start time of an annotation included in the metadata, and a fifth field indicating an end time of the annotation included in the metadata.

6. The method of claim 1, wherein the annotation group comprises information regarding at least one of a semantic or a characteristic of the signal.

7. The method of claim 1, wherein the generating of the bitstream comprises encoding the metadata based on audio coding for machines (ACoM).

8. A method of operating a decoder, the method comprising:
obtaining a bitstream of an encoded signal; and
decoding the bitstream to reconstruct metadata of the signal,
wherein the metadata comprises an annotation group representing information expected to be inferred by a machine while performing a task related to the signal.

9. The method of claim 8, wherein the metadata further comprises a first field indicating a number of annotation groups included in the metadata.

10. The method of claim 8, wherein the annotation group comprises a second field indicating a type of annotation included in the metadata.

11. The method of claim 8, wherein the annotation group comprises a third field indicating a time-varying annotation value included in the metadata.

12. The method of claim 8, wherein the annotation group comprises a fourth field indicating a start time of an annotation included in the metadata, and a fifth field indicating an end time of the annotation included in the metadata.

13. The method of claim 8, wherein the annotation group comprises information regarding at least one of a semantic or a characteristic of the signal.

14. The method of claim 8, wherein the reconstructing of the metadata comprises decoding the bitstream based on audio coding for machines (ACoM).

15. A non-transitory computer-readable storage medium storing instructions that,
when executed by a processor, cause the processor to perform the method of claim 1.

16. An encoder comprising:
a processor; and
memory storing instructions,
wherein the instructions, when executed by the processor, cause the encoder to:
obtain metadata of a signal; and
encode the metadata to generate a bitstream corresponding to the metadata,
wherein the metadata comprises an annotation group representing information expected to be inferred by a machine while performing a task related to the signal.

17. The encoder of claim 16, wherein the metadata further comprises a first field indicating a number of annotation groups included in the metadata.

18. The encoder of claim 16, wherein the annotation group comprises a second field indicating a type of annotation included in the metadata.

19. The encoder of claim 16, wherein the annotation group comprises a third field indicating a time-varying annotation value included in the metadata.

20. The encoder of claim 16, wherein the annotation group comprises a fourth field indicating a start time of an annotation included in the metadata, and a fifth field indicating an end time of the annotation included in the metadata.
